(19) United States
(12) Patent Application Publication
(10) Pub. No.: US 2006/0258319 A1
(43) Pub. Date: Nov. 16, 2006

(54) Integrated wide bandwidth attenuating-and-amplifying circuit

(76) Inventor: Bernd Wuppermann, Pacifica, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/125,926

(22) Filed: May 10, 2005

(51) Int. Cl. H04B 1/28

(52) U.S. Cl. 455/333

(57) ABSTRACT

An attenuating-and-amplifying circuit and method for producing a voltage-adjusted output signal of an input signal uses a voltage divider and a number of switchable amplifier units connected to the voltage divider to adjust the gain or attenuation of the input signal. The voltage divider includes a number of tapping nodes, which are connected to the switchable amplifier units. The voltage divider is configured to provide different voltage attenuated signals of the input signal. The switchable amplifier units can be selectively activated to adjust with respect to voltage at least one of the different voltage attenuated signals to produce the voltage-adjusted output signal.

### BACKGROUND OF THE INVENTION

Attenuators and amplifiers are frequently used in analog signal processing equipments to adjust the overall gain in high-speed analog signal paths. As an example, an attenuator may be used on the input channels of an oscilloscope to provide attenuated signals of the input signals, which can then be amplified for signal processing. In a given analog signal processing equipment, the attenuator may or may not be integrated with the amplifier, which is typically a part of a high-speed mixed signal processing system fabricated on a silicon integrated circuit (IC) chip using bipolar or bipolar complementary metal oxide semiconductor (BiCMOS) technology.

In a conventional gain attenuating technique of interest that uses a non-integrated attenuator, the attenuator is based on resistive voltage dividers, which are fabricated using Gallium Arsenide (GaAs) metal semiconductor field effect transistor (MESFET) switches or relays. Although the non-integrated attenuator provides good performance, the use of this non-integrated attenuator results in added cost, increased board area and more signal reflections.

In a conventional gain attenuating technique of interest that uses an integrated attenuator, the attenuator is based on current steering in a differential pair amplifier. The integrated attenuator includes a pair of attenuating transistors along each current path of the differential pair amplifier. A concern with this technique is that the thermal noise of the attenuator is increased due to the additional active devices, i.e., the attenuating transistors. Another concern is that the amplifying transistors of the differential pair amplifier need to be connected to large degeneration resistors in order to provide low distortion even for the maximum input signal. Furthermore, this technique requires a large power supply voltage due to the additional active devices and the large voltage drop across the degeneration resistors, which results in an increased power consumption.

In view of these concerns, what is needed is an attenuating-and-amplifying circuit that addresses some or all of the concerns of the conventional gain attenuating techniques that use either a non-integrated attenuator or an integrated attenuator.

### SUMMARY OF THE INVENTION

An attenuating-and-amplifying circuit and method for producing a voltage-adjusted output signal of an input signal uses a voltage divider and a number of switchable amplifier units connected to the voltage divider to adjust the gain or attenuation of the input signal. The voltage divider includes a number of tapping nodes, which are connected to the switchable amplifier units. The voltage divider is configured to provide different voltage attenuated signals of the input signal. The switchable amplifier units can be selectively activated to adjust with respect to voltage at least one of the different voltage attenuated signals to produce the voltage-adjusted output signal.

An attenuating-and-amplifying circuit in accordance with an embodiment of the invention comprises an input, a voltage divider, an amplifier and an output. The input is used to receive an input signal. The voltage divider is connected to the input, and includes a plurality of tapping nodes. The voltage divider is configured to provide different voltage attenuated signals of the input signal in parallel at the tapping nodes. The amplifier includes a plurality of switchable amplifier units that are connected to the tapping nodes of the voltage divider to receive the different voltage attenuated signals. Each of the switchable amplifier units is configured to be selectively activated and deactivated such that at least one of the different voltage attenuated signals can be selectively adjusted with respect to voltage by the switchable amplifier units. The output is connected to the switchable amplifier units. The output is used to output an output signal in response to at least one of the different voltage attenuated signals that has been selectively adjusted by the switchable amplifier units.

A method for producing a voltage-adjusted output signal of an input signal in accordance with an embodiment of the invention comprises receiving the input signal, attenuating the input signal with respect to voltage to produce different voltage attenuated signals in parallel, and selectively adjusting with respect to voltage at least one of the different attenuated signals to produce the voltage-adjusted output signal.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of an integrated attenuating-and-amplifying circuit in accordance with an embodiment of the invention.

FIG. 2 is a diagram of a switchable current source included in the integrated attenuating-and-amplifying circuit of FIG. 1 in accordance with an embodiment of the invention.

FIG. 3 is a diagram of a differential pair amplifier unit in accordance with an alternative embodiment of the invention, which may be included in the integrated attenuating-and-amplifying circuit of FIG. 1.

FIG. 4 is a flow diagram of a method for producing a voltage-adjusted output signal of an input signal in accordance with an embodiment of the invention.

### DETAILED DESCRIPTION OF THE INVENTION

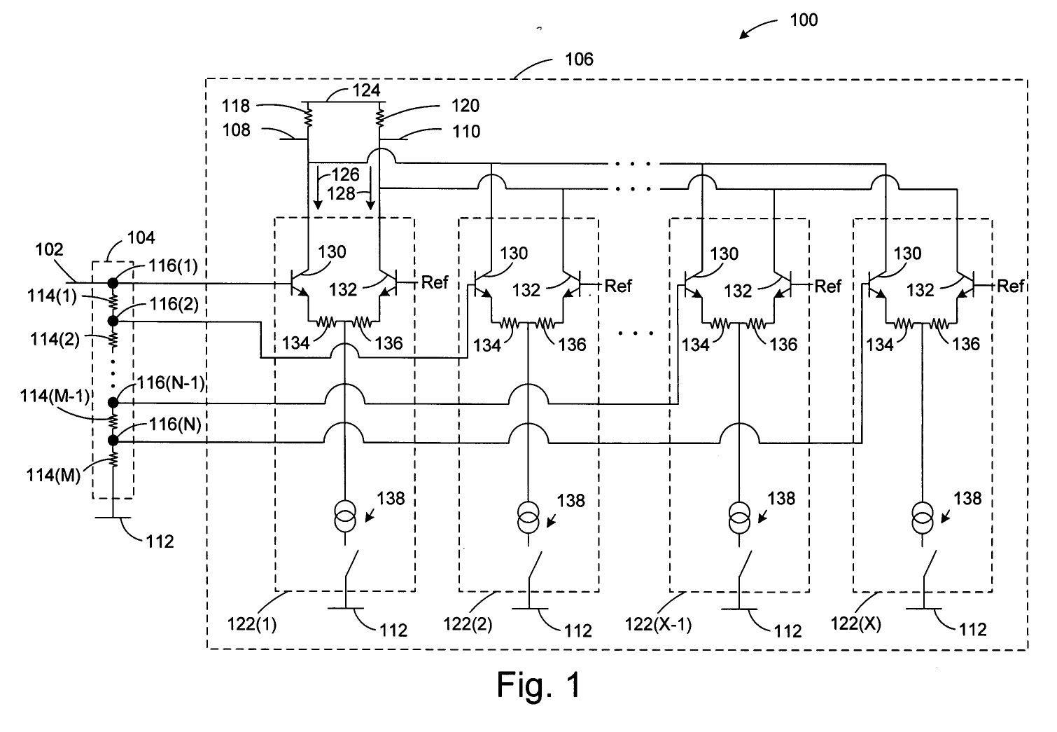

With reference to FIG. 1, an integrated wide bandwidth attenuating-and-amplifying circuit 100 in accordance with an embodiment of the invention is described. In most cases, the attenuating-and-amplifying circuit 100 operates to selectively adjust the overall gain or attenuation to produce a voltage-adjusted output signal of an input signal. However, the attenuating-and-amplifying circuit 100 may also produce an output signal that is equivalent to the input signal with respect to voltage. The design of the attenuating-and-amplifying circuit 100 allows the circuit to be fabricated on a single silicon integrated circuit (IC) chip using bipolar or bipolar complementary metal oxide semiconductor (BiCMOS) technology, which resolves some of the issues associated with the use of a non-integrated attenuator, such as added cost and increased board area. Furthermore, the design of the attenuating-and-amplifying circuit 100 requires a lower power supply than comparable conventional circuit, which reduces power consumption. Other advantages of the attenuating-and-amplifying circuit 100 are described below.

As shown in FIG. 1, the attenuating-and-amplifying circuit 100 comprises an input 102, a voltage divider 104, an amplifier 106 and outputs 108 and 110. The input 102 is used to receive an input signal, which may be an input signal to an oscilloscope. The input 102 is connected to the voltage divider 104. The voltage divider 104 is connected between the input 102 and a low voltage terminal 112, e.g., ground. The voltage divider 104 comprises resistors 114(1), 114(2) . . . 114(M−1) and 114(M), where M is an integer greater than one. The resistors 114(1), 114(2) . . . 114(M−1) and 114(M) are connected in series between the input 102 and the low voltage terminal 112. Although each of the resistors 114(1), 114(2) . . . 114(M−1) and 114(M) is illustrated in FIG. 1 as being a single resistor, one or more of these resistors may be implemented as series of resistors. The voltage divider 104 also includes a number of tapping nodes 116(1), 116(2) . . . 116(N−1) and 116(N), where N is also an integer greater than one. The tapping nodes 116(1), 116(2) . . . 116(N−1) and 116(N) are positioned along the string of series resistors 114(1), 114(2) . . . 114(M−1) and 114(M). In an embodiment, the number of resistors 114(1), 114(2) . . . 114(M−1) and 114(M) may equal the number of tapping nodes 116(1), 116(2) . . . 116(N−1) and 116(N), i.e., M=N. However, in other embodiments, the number of resistors 114(1), 114(2) . . . 114(M−1) and 114(M) may not equal the number of tapping nodes 116(1), 116(2) . . . 116(N−1) and 116(N), i.e., M≠N. The number of resistors 114(1), 114(2) . . . 114(M−1) and 114(M) and the tapping nodes 116(1), 116(2) . . . 116(N−1) and 116(N) included in the voltage divider 104 can be varied as needed, as explained below.

In FIG. 1, the tapping node 116(1) is positioned between the resistor 114(1) and the input 102. The tapping node 116(2) is positioned between the resistors 114(1) and 114(2). Similarly, the tapping node 116(N) is positioned between the resistors 114(M−1) and 114(M). Other tapping nodes between the tapping nodes 116(2) and 116(N) are similarly positioned between resistors that are positioned between the resistors 114(1) and 114(M).

The voltage divider 104 provides different voltage attenuated signals of the input signal in parallel at the tapping nodes 116(1), 116(2) . . . 116(N−1) and 116(N). That is, the voltage divider 104 receives the input signal and produces a particular attenuated signal at each of the tapping nodes 116(1), 116(2) . . . 116(N−1) and 116(N). The amount of attenuation provided at each tapping node 116(1), 116(2) . . . 116(N−1) or 116(N) depends on the location of that tapping node with respect to the series resistors 114(1), 114(2) . . . 114(M−1) and 114(M) of the voltage divider 104. Since the tapping nodes 116(1), 116(2) . . . 116(N−1) and 116(N) are positioned at different locations along the string of series resistors 114(1), 114(2) . . . 114(M−1) and 114(M), each tapping node provides a different voltage divider ratio, which depends on the voltage drop provided by the resistors above that tapping node. The lowest divider ratio is provided by the tapping node 116(1), while the highest divider ratio is provided by the tapping node 116(N). The other tapping nodes 116(2) . . . 116(N−2) and 116(N−1) provide different divider ratios between the lowest and the highest divider ratios. In FIG. 1, the tapping node 116(2) provides the second lowest divider ratio and the tapping node 116(N−1) provides the second highest divider ratio. The divider ratios provided at the tapping nodes 116(1), 116(2) . . . 116(N−1) and 116(N) can be adjusted by changing the resistance of one or more of the series resistors 114(1), 114(2) . . . 114(M−1) and 114(M).

The amplifier 106 of the attenuating-and-amplifying circuit 100 is connected to the voltage divider 104 at the tapping nodes 116(1), 116(2) . . . 116(N−1) and 116(N) to receive the attenuated signals provided by the voltage divider. The amplifier 106 includes output resistors 118 and 120 and a number of switchable differential pair amplifier units 122(1), 122(2) . . . 122(X−1) and 122(X). The output resistor 118 is connected to a high voltage terminal 124, e.g., a supply voltage terminal, on a signal path 126. Similarly, the output resistor 120 is connected to the high voltage terminal 124 on a signal path 128, which is parallel to the signal path 126. The output 108 of the attenuating-and-amplifying circuit 100 is connected to the signal path 126 below the output resistor 118, while the output 110 is connected to the signal path 218 below the output resistor 120.

The switchable differential pair amplifier units 122(1), 122(2) . . . 122(X−1) and 122(X) of the amplifier 106 are connected to the signal paths 126 and 128 and the low voltage terminal 112. The differential pair amplifier units 122(1), 122(2) . . . 122(X−1) and 122(X) are also connected to the tapping nodes 116(1), 116(2) . . . 116(N−1) and 116(N) of the voltage divider 104 to receive the attenuated signals of the input signal at the tapping nodes. In the illustrated embodiment, each of the differential pair amplifier units 122(1), 122(2) . . . 122(X−1) and 122(X) is connected to a different tapping node of the voltage divider 104 to receive the attenuated signal of the input signal at that tapping node. Thus, the number of differential pair amplifier units 122(1), 122(2) . . . 122(X−1) and 122(X) included in the amplifier 106 equals the number of tapping nodes 116(1), 116(2) . . . 116(N−1) and 116(N) included in the voltage divider 104, i.e., X=N. In other embodiments, more than one of the differential pair amplifier units 122(1), 122(2) . . . 122(X−1) and 122(X) may be connected to the same tapping node of the voltage divider 104 to receive the attenuated signal of the input signal at that tapping node. Thus, in this embodiment, the number of differential pair amplifier units 122(1), 122(2) . . . 122(X−1) and 122(X) included in the amplifier 106 does not equal the number of tapping nodes 116(1), 116(2) . . . 116(N−1) and 116(N) included in the voltage divider 104, i.e., X≠N. The exact number of differential pair amplifier units 122(1), 122(2) . . . 122(N−1) and 122(N) included in the amplifier 106 depends on the desired resolution of the output signal. As an example, the amplifier 106 may include four differential pair amplifier units.

As described in more detail below, the differential pair amplifier units 122(1), 122(2) . . . 122(X−1) and 122(X) are switchable so that one or more differential pair amplifier units can be selectively activated (turned ON), while the remaining differential pair amplifier units are deactivated (turned OFF). When a differential pair amplifier unit is activated, current is allowed to be conducted through that differential pair amplifier unit. Each activated differential pair amplifier unit adjusts with respect to voltage the attenuated signal received from the respective tapping node of the voltage divider 104 to produce the output signal at the output 108. That is, each activated differential pair amplifier unit may amplify or attenuate the attenuated signal received from the respective tapping node of the voltage divider 104. The output signal at the output 108 is one of two differential signals. The other differential signal is produced at the output 110. However, when a differential pair amplifier unit is deactivated, current is not allowed to be conducted through that differential pair amplifier unit. Thus, the attenuated signals applied to the deactivated differential pair amplifier units are not adjusted with respect to voltage, and do not contribute to the output signal at the output 108. Therefore, the amount of gain or attenuation provided by the amplifier 106 depends on which differential pair amplifier units are activated, as well as the input signal. Consequently, the overall gain or attenuation of the attenuating-and-amplifying circuit 100 can be adjusted by selectively activating and deactivating the differential pair amplifier units 122(1), 122(2) . . . 122(X−1) and 122(X).

In an embodiment, the differential pair amplifier units 122(1), 122(2) . . . 122(X−1) and 122(X) are structurally identical. That is, each differential pair amplifier unit includes the same components of the same size as the other differential pair amplifier units. Thus, only the differential pair amplifier unit 122(1) will be described in detail below. However, in other embodiments, the differential pair amplifier units 122(1), 122(2) . . . 122(X−1) and 122(X) may not be structurally identical with respect size and type of components.

The differential pair amplifier unit 122(1) includes differential bipolar transistors 130 and 132, degeneration resistors 134 and 136 and a switchable current source 138. The bipolar transistor 130 and the degeneration resistor 134 are connected in series from the signal path 126 to the switchable current source 138. The collector of the bipolar transistor 130 is connected to the signal path 126, while the emitter of the bipolar transistor 130 is connected to the resistor 134. The base of the bipolar transistor 130 is connected to the associated tapping node of the voltage divider 104, i.e., the tapping node 116(1). Thus, the bipolar transistor 130 is controlled by the attenuated signal at the tapping node 116(1). The bipolar transistor 132 and the degeneration resistor 136 are connected in series from the signal path 128 to the switchable current source 138. The collector of the bipolar transistor 132 is connected to the signal path 128, while the emitter of the bipolar transistor 132 is connected to the resistor 136. The base of the bipolar transistor 132 is connected to a reference voltage source (not shown) to receive a reference signal. Thus, the bipolar transistor 132 is controlled by the applied reference signal.

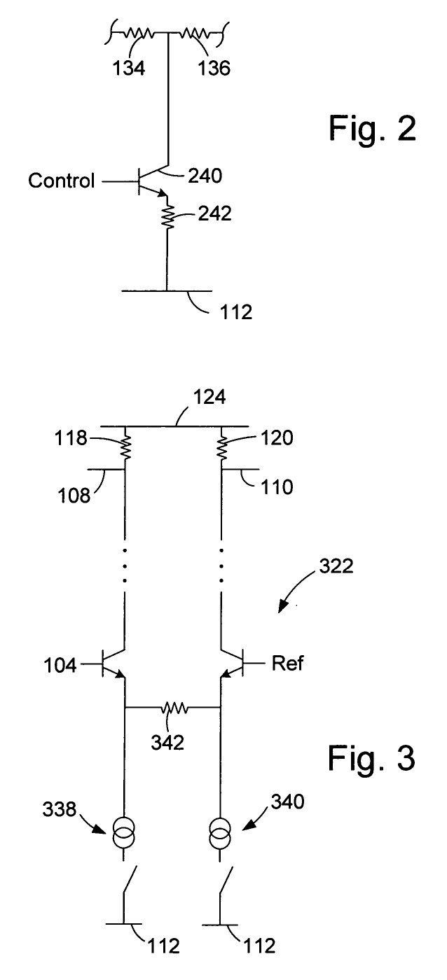

The switchable current source 138 of the differential pair amplifier unit 122(1) is connected to the resistors 134 and 136 and the low voltage terminal 112. The switchable current source 138 controls the activation and deactivation of the differential pair amplifier unit 122(1). In an embodiment, as illustrated in FIG. 2, the switchable current source 138 includes a bipolar transistor 240 and a resistor 242 connected in series between the resistors 134 and 136 and the low voltage terminal 112. The collector of the bipolar transistor 240 is connected to the resistors 134 and 136, while the emitter of the bipolar transistor 240 is connected to the resistor 242. The bipolar transistor 240 is controlled by a control signal applied to the base of the bipolar transistor 240. When an ON control signal is applied to the base of the bipolar transistor 240, the bipolar transistor 240 conducts current, which activates the switchable current source 138, and thus, the differential pair amplifier unit 122(1). When an OFF control signal is applied to the base of the bipolar transistor 240, the bipolar transistor 240 does not conduct current, which deactivates the switchable current source 138, and thus, deactivates the differential pair amplifier unit 122(1).

In an embodiment, the switchable current sources 138 of the differential pair amplifier units 122(1), 122(2) . . . 122(X−1) and 122(X) are configured and operated so that each current source conducts the same amount of current. In another embodiment, the switchable current sources 138 of the differential pair amplifier units 122(1), 122(2) . . . 122(X−1) and 122(X) are configured and operated so that each current source can conduct a different amount of current.

The operation of the attenuating-and-amplifying circuit 100 is now described with reference to FIGS. 1 and 2. An input analog signal is received at the input 102 of the attenuating-and-amplifying circuit 100. Since the voltage divider 104 is connected to the input 102, the input analog signal is applied to the voltage divider, which produces different voltage attenuated signals of the input signal at the tapping nodes 116(1), 116(2) . . . 116(N−1) and 116(N) in parallel. The different voltage attenuated signals of the input signal at the tapping nodes 116(1), 116(2) . . . 116(N−1) and 116(N) are then transmitted to the respective differential pair amplifier units 122(1), 122(2) . . . 122(X−1) and 122(X). Specifically, the attenuated signal at a particular tapping node is applied to the base of the differential bipolar transistor 130 of the differential pair amplifier unit(s) connected to that particular tapping node. In addition, reference signals are applied to the differential bipolar transistors 132 of the differential pair amplifier units 122(1), 122(2) . . . 122(X−1) and 122(X).

The differential pair amplifier units 122(1), 122(2) . . . 122(X−1) and 122(X) are then selectively activated and deactivated by control signals applied to the switchable current sources 138 of the differential pair amplifier units. Specifically, a control signal is applied to the base of the bipolar transistor 240 of the switchable current source 138 for each differential pair amplifier unit, as shown in FIG. 2, to selectively activate or deactivate that differential pair amplifier unit. In response to the received attenuated signals, the activated differential pair amplifier units provide gain or attenuation to the voltage attenuated signals. However, the deactivated differential pair amplifier units do not provide any gain or attenuation to the applied voltage attenuated signals.

The attenuated signal applied to the base of the bipolar transistor 130 of each activated differential pair amplifier unit 122(1), 122(2) . . . 122(X−1) or 122(X) controls the amount of current conducted through the bipolar transistor 130, which is reflected in the output signal at the output 108. Thus, the output signal at the output 108 is the result of the combined current conducted through the bipolar transistor 130 of each activated differential pair amplifier unit 122(1), 122(2) . . . 122(X−1) or 122(X). Consequently, the output signal at the output 108 depends not only on the input signal at the input 102 but also the differential pair amplifier units 122(1), 122(2) . . . 122(X−1) and 122(X) of the amplifier 106 that have been activated. Consequently, the output signal of the attenuating-and-amplifying circuit 100 can be controlled by selectively activating one or more of the differential pair amplifier units 122(1), 122(2) . . . 122(X−1) and 122(X) of the amplifier 106.

Turning now to FIG. 3, a switchable differential pair amplifier unit 322 in accordance with an alternative embodiment of the invention is shown. The differential pair amplifier unit 322 may replace one or more of the differential pair amplifier units 122(1), 122(2) . . . 122(N−1) and 122(N) of the attenuating-and-amplifying circuit 100. In FIG. 3, the same reference numbers of FIG. 1 are used to reference similar elements. The differential pair amplifier unit 322 includes the differential bipolar transistors 130 and 132. The collector of the differential transistor 130 is connected to the output resistor 118. The collector of the differential transistor 132 is connected to the output resistor 120. The base of the differential transistor 130 is connected to one of the tapping nodes 116(1), 116(2) . . . 116(N−1) and 116(N) of the voltage divider 104 to receive the voltage attenuated signal from that tapping node. The base of the differential transistor 132 is connected a reference voltage source (not shown) to receive a reference signal. The emitter of the differential transistor 130 is connected to a switchable current source 338, while the emitter of the differential bipolar transistor 132 is connected to a switchable current source 340. Similar to the switchable current source 138, the switchable current sources 338 and 340 may each be comprised of a bipolar transistor and a resistor that are connected in series, as illustrated in FIG. 2. The differential pair amplifier unit 322 includes a single degeneration resistor 342, which is connected between the emitters of the differential transistors 130 and 132. The differential pair amplifier unit 322 is selectively activated by turning on the switchable current sources 338 and 340.

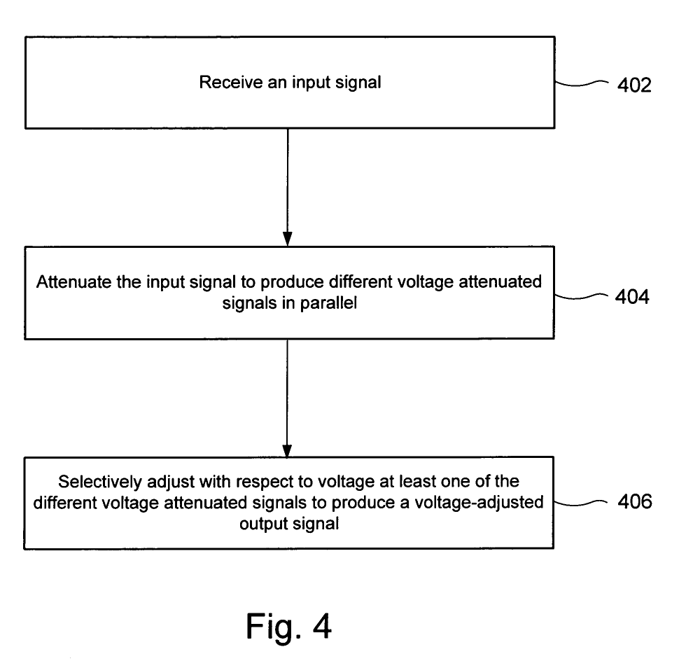

A method for providing a voltage-adjusted output signal of an input signal in accordance with an embodiment of the invention is described with reference to the flow diagram of FIG. 4. At block 402, the input signal is received. Next, at block 404, the input signal is attenuated to produce different voltage attenuated signals in parallel. In an embodiment, the voltage attenuated signals are produced using a voltage divider that includes a chain of series resistors. The voltage attenuated signals are provided at various tapping nodes along the chain of series resistors. Next, at block 406, at least one of the different voltage attenuated signals is selectively adjusted with respect to voltage to produce the voltage-adjusted output signal. In an embodiment, the selected voltage attenuated signal is adjusted using a number of differential pair amplifier units, which are each connected to a particular tapping node of the voltage divider to receive the voltage attenuated signal at that tapping node. The differential pair amplifier units are configured to be switchable between an activated state and a deactivated state. By selectively activating one or more of the differential pair amplifier units, the voltage attenuated signals applied to the activated differential pair amplifier units are adjusted to produce the voltage-adjusted output signals. In contrast, the voltage attenuated signals applied to the deactivated differential pair amplifier units are not adjusted by the deactivated differential pair units, and thus, do not contribute to the amplified output signal.

Although specific embodiments of the invention have been described and illustrated, the invention is not to be limited to the specific forms or arrangements of parts as described and illustrated herein. As an example, although the transistors 130, 132 and 240 of the attenuating-and-amplifying circuit 100 have been described herein as being bipolar transistors, these transistors can be other types of transistors, such as metal oxide semiconductor (MOS) transistors. The scope of the invention is to be defined by the claims appended hereto and their equivalents.

What is claimed is:

1. An attenuating-and-amplifying circuit comprising:
an input to receive an input signal;
a voltage divider connected to said input, said voltage divider including a plurality of tapping nodes, said voltage divider being configured to provide different voltage attenuated signals of said input signal in parallel at said tapping nodes;
an amplifier including a plurality of switchable amplifier units that are connected to said tapping nodes of said voltage divider to receive said different voltage attenuated signals, each of said switchable amplifier units being configured to be selectively activated and deactivated such that at least one of said different voltage attenuated signals can be selectively adjusted with respect to voltage by said switchable amplifier units; and
an output connected to said switchable amplifier units to output an output signal in response to at least one of said different voltage attenuated signals that has been selectively adjusted by said switchable amplifier units.

2. The circuit of claim 1 wherein said voltage divider includes a plurality of series resistors connected to said input, at least one of said tapping nodes being positioned between said series resistors.

3. The circuit of claim 1 wherein each of said switchable amplifier units includes first and second differential transistors, said first differential transistor being controlled by a received voltage attenuated signal from one of said tapping nodes of said voltage divider, said second differential transistor being controlled by a reference signal.

4. The circuit of claim 3 wherein each of said switchable amplifier units includes a switchable current source connected to said first differential transistor, said switchable current source being configured to be selectively activated.

5. The circuit of claim 4 wherein said switchable current source includes a transistor and a resistor that are connected in series, said transistor being controlled by an applied control signal to activate or deactivate said switchable current source.

6. The circuit of claim 4 wherein each of said switchable amplifier units includes a degeneration resistor, said degeneration resistor being positioned between said first differential transistor and said second differential transistor.

7. The circuit of claim 4 wherein each of said switchable amplifier units includes a second switchable current source connected to said second differential transistor, said second switchable current source being configured to be selectively activated.

8. The circuit of claim 3 wherein said amplifier includes first and second output resistors, said first output resistor being connected to said first differential transistor of each of said switchable amplifier units, said second output resistor being connected to said second differential transistor of each of said switchable amplifier units.

9. An attenuating-and-amplifying circuit comprising:
an input to receive an input signal;
a voltage divider connected to said input, said voltage divider including a plurality of series resistors, said voltage divider further including tapping nodes positioned along said series resistors, said voltage divider being configured to provide different voltage attenuated signals of said input signal in parallel at said tapping nodes;
a plurality of switchable differential pair amplifier units that are connected to said tapping nodes of said voltage divider to receive said different voltage attenuated signals, each of said switchable differential pair amplifier units being configured to be selectively activated and deactivated such that at least one of said different voltage attenuated signals can be selectively adjusted with respect to voltage by said switchable differential pair amplifier units; and
an output connected to said switchable differential pair amplifier units to output an output signal in response to at least one of said different voltage attenuated signals that has been selectively adjusted by said switchable differential pair amplifier units.

10. The circuit of claim 9 wherein each of said switchable differential pair amplifier units includes first and second differential transistors, said first differential transistor being controlled by a received voltage attenuated signal from one of said tapping nodes of said voltage divider, said second differential transistor being controlled by a reference signal.

11. The circuit of claim 10 wherein each of said switchable differential pair amplifier units includes a switchable current source connected to said first differential transistor, said switchable current source being configured to be selectively activated.

12. The circuit of claim 11 wherein said switchable current source includes a transistor and a resistor that are connected in series, said transistor being controlled by an applied control signal to activate or deactivate said switchable current source.

13. The circuit of claim 11 wherein each of said switchable differential pair amplifier units includes a degeneration resistor, said degeneration resistor being positioned between said first differential transistor and said second differential transistor.

14. The circuit of claim 11 wherein each of said switchable amplifier units includes a second switchable current source connected to said second differential transistor, said second switchable current source being configured to be selectively activated.

15. The circuit of claim 10 further comprising first and second output resistors, said first output resistor being connected to said first differential transistor of each of said switchable differential pair amplifier units, said second output resistor being connected to said second differential transistor of each of said switchable differential pair amplifier units.

16. A method for producing a voltage-adjusted output signal of an input signal, said method comprising:
receiving said input signal;
attenuating said input signal with respect to voltage to produce different voltage attenuated signals in parallel; and
selectively adjusting with respect to voltage at least one of said different attenuated signals to produce said voltage-adjusted output signal.

17. The method of claim 16 wherein said attenuating includes applying said input signal to a voltage divider that includes a plurality of series resistors, said voltage divider further including tapping nodes positioned along said series resistors, said voltage divider being configured to provide said different voltage attenuated signals of said input signal in parallel at said tapping nodes.

18. The method of claim 16 further comprising providing a plurality of switchable amplifier units connected to receive said different voltage attenuated signals, and wherein said selectively adjusting includes selectively activating at least one of said switchable amplifier units.

19. The method of claim 18 wherein said selectively activating includes selectively activating a switchable current source of said at least one of said switchable amplifier units.

20. The method of claim 19 wherein said selectively activating said switchable current source includes controlling a transistor of said switchable current source to selectively conduct current through said switchable current source.
